(19) United States
(12) Patent Application Publication
(10) Pub. No.: US 2025/0210753 A1
(43) Pub. Date: Jun. 26, 2025

(54) THERMAL REGULATION DEVICE FOR AN ELECTRICAL ENERGY STORAGE MEMBER

(71) Applicant: VALEO SYSTEMES THERMIQUES, Le Mesnil-Saint-Denis (FR)

(72) Inventors: Guillaume Gardere, Le Mesnil-Saint-Denis Cedex (FR); Sergio Da Costa Pito, Le Mesnil-Saint-Denis Cedex (FR)

(73) Assignee: VALEO SYSTEMES THERMIQUES, Le Mesnil-Saint-Denis (FR)

(21) Appl. No.: 18/849,957

(22) PCT Filed: Mar. 1, 2023
(86) PCT No.: PCT/EP2023/055209

§ 371 Date: Sep. 23, 2024

(30) Foreign Application Priority Data
Mar. 23, 2022 (FR) FR2202567

(51) Int. Cl. H01M 10/6556; H01M 10/613; H01M 10/625; H01M 10/6554; H01M 10/6568

(52) U.S. Cl. CPC H01M 10/6556; H01M 10/613; H01M 10/625; H01M 10/6554; H01M 10/6568

(57) ABSTRACT

A thermal regulation device for an electric energy storage member includes at least one support plate and at least one distribution plate secured to each other so as to delimit between them one or more circulation ducts for circulating a refrigerant, where the support plate and the distribution plate are two substantially planar plates secured to each other by means of ribs extending perpendicularly to each of the plates, and at least one circulation duct being delimited transversely, on at least one side, by a set of two parallel ribs.

The present invention pertains to the field of thermal regulation devices, and more specifically to means for regulating the temperature of electric energy storage members in vehicles.

It is currently known to fit electric, thermal or hybrid vehicles with electric energy storage members that are notably intended to supply electric power to an electric motor of the vehicle. These electric energy storage members are usually made up of electric energy storage cells positioned in a battery pack.

Car manufacturers are currently seeking to supply more powerful electric or hybrid vehicles with greater electric range. To do so, more battery packs and/or larger battery packs are being installed in these electric or hybrid vehicles. It is known to install all or at least some of these battery packs in the floor of the vehicle, substantially across the entire width of the vehicle.

During operation of the vehicle, the battery packs may give off a significant amount of heat and may therefore be subjected to high temperatures that could cause them to be damaged or even destroyed in some cases. As a result, they must be cooled to keep them in good condition, thereby ensuring the reliability, range and performance of the vehicle. Furthermore, the battery packs may work less efficiently in low temperatures, with the electric or electronic components of these battery packs requiring a warm-up time before operating at full efficiency.

For this purpose, one or more thermal regulation devices for regulating the temperature of the battery packs are used to provide the heating and/or cooling functions for the electric or electronic components inside these battery packs, thereby optimizing operation of the different components.

A refrigerant fluid is usually circulated through these thermal regulation devices, said refrigerant fluid being able to absorb the heat emitted by each battery pack in order to cool it, or to heat it if the temperature of the battery pack is too low to work properly, as required.

The thermal regulation devices may for example be made of a flat plate onto which a stamped plate is crimped or riveted, so as to form ducts between the flat plate and the reliefs formed in the stamped plate for the refrigerant fluid to flow through. This type of thermal regulation device usually extends over the entire surface formed by the corresponding battery pack, and each of the storage cells is in contact with at least one of the plates, so that the refrigerant fluid circulating in the duct of the thermal regulation device is able to exchange calories with all of the electric energy storage cells.

The plates between which the heat-exchange fluid circulates are usually made of metal, for example thin sheets of aluminum, notably to enable the heat transfer between the storage cells to be cooled and the refrigerant fluid intended to capture the calories. The technical problem addressed by the present invention is notably the carbon footprint of a thermal regulation device that uses large quantities of aluminum, notably in the context of increasing the electric range of vehicles and therefore the need for large plates to form the thermal regulation device. The invention is therefore intended to reduce, notably, the carbon dioxide emissions generated by the structure and the assembly method for heat exchangers.

The present invention is intended to overcome the drawbacks in the prior art with a thermal regulation device for cooling an energy storage member, comprising at least one support plate and one distribution plate secured to each other so as to delimit ducts for circulating a refrigerant fluid therebetween, the thermal regulation device being characterized in that the support plate and the distribution plate are two substantially planar plates secured to each other by means of ribs extending perpendicularly to each of the plates, at least one of the circulation ducts being delimited transversely, on at least one side, by a set of two parallel ribs.

In a context in which at least one of the plates may be made of a non-metal material to limit the carbon footprint of the thermal regulation device, it is then advantageous to fasten the plates together using ribs arranged perpendicularly between the two plates, in order to concentrate the fastening operation at the ends of the ribs, be it by bonding or by thermal deformation of the ends of the ribs to fuse them to the corresponding plate.

The presence of two parallel ribs to form a side wall delimiting a duct helps to manage the risk of leakage, since the dual ribs create a buffer zone within which a few drops of refrigerant fluid may remain without spreading uncontrollably, for example outside the plates and consequently toward the electrical storage members.

It should be noted that the thermal regulation device is notably useful for cooling electric energy storage members, and it is in the context of this application that the invention is specifically described below. However, it may be necessary to thermally regulate the electric energy storage member by increasing the temperature thereof, for example during the ignition phases of the vehicle in cold weather, and the structure of the thermal regulation device described below provides, in this case, the same advantages as those set out below.

According to an optional feature of the invention, the two ribs of a set of two parallel ribs each extend in a main direction of the circulation duct that said set participates in delimiting. In other words, the two ribs of a set laterally delimiting a circulation duct follow the intended shape of the circulation duct between the plates. There is a buffer zone of constant width along the circulation duct, the width being defined by the distance between the two ribs parallel to the planes of the support and distribution plates.

These two parallel ribs comprise a guide rib, which participates directly in delimiting the duct, and a reinforcing rib, which extends in parallel, and which is intended to create an additional barrier to prevent fluid from flowing out of the circulation duct.

According to another optional feature of the invention, the support plate has an outer face intended to be in contact with the energy storage member and an inner face facing the distribution plate. In other words, the circulation ducts formed between the plates of the thermal regulation device are all delimited at one end by the inner face of the support plate, which is kept at a distance from the distribution plate by the interposed ribs.

According to another optional feature of the invention, the distribution plate has an inner face intended to face the support plate, the sets of ribs participating in delimiting the circulation ducts being arranged substantially perpendicular to the inner face of the distribution plate and to the inner face of the support plate.

According to another optional feature of the invention, a partitioning rib is arranged across two ribs of a set of ribs. Such a partitioning rib is formed to be connected at these ends to each of the ribs, i.e. the guide rib and the reinforcement rib, of a set of two ribs, and to prevent the circulation of refrigerant fluid within the buffer zone.

According to another optional feature of the invention, the ratio between the width of a circulation duct and the height of the ribs is between 1:5 and 1:7. With a minimum height of 2 mm, the width is in this case preferably 10 mm. The width of the duct is the distance between two guide ribs participating directly in delimiting this duct. The height of the ribs is measured once the support plate is secured to the ends of the ribs, so that the height of the ribs corresponds to the distance between the two plates.

According to another optional feature of the invention, the support plate and the distribution plate are made of different materials.

According to another optional feature of the invention, the support plate is made of a metal and the distribution plate is made of a plastic. Using plastic makes the thermal regulation device more lightweight and reduces the carbon footprint thereof, with only the support plate still being made of metal, notably aluminum, to ensure efficient thermal transfer between the refrigerant fluid and the electric energy storage member, the temperature of which has to be regulated.

According to another optional feature of the invention, the ribs are overmolded on the distribution plate. The ribs may notably be made of the same material as the distribution plate, or at least of a plastic, thermoplastic or composite that is compatible with the material used to make the distribution plate for an overmolding operation.

According to another optional feature of the invention, each of the ribs is formed by a local deformation of the distribution plate.

Other features, details and advantages of the invention are set out more clearly in the description below as well as in several example embodiments provided by way of non-limiting examples with reference to the schematic drawings attached, in which:

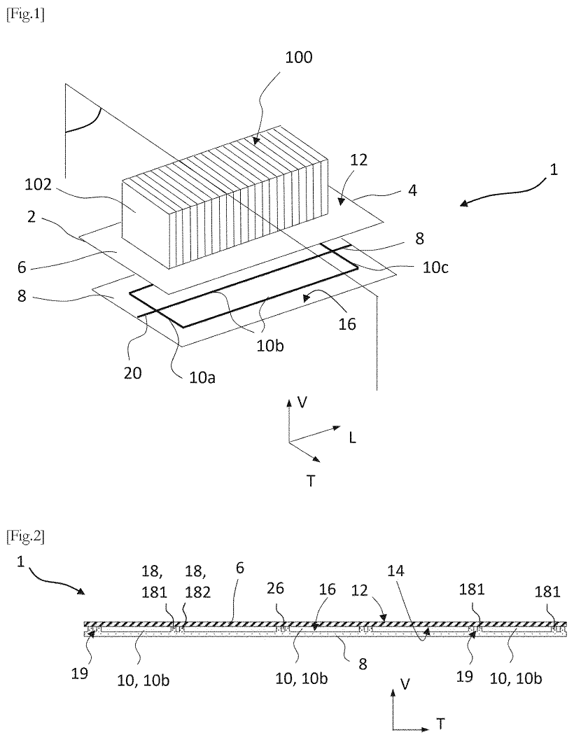

FIG. 1s a schematic view of an electric energy storage member and an associated thermal regulation device, in this case an exploded view with a distribution plate and a support plate shown at a distance from one another to reveal portions of refrigerant fluid circulation ducts,

FIG. 2 shows the thermal regulation device in FIG. 1 in cross section and in an assembled position with the support plate attached to the sets of ribs rigidly connected to the distribution plate, the thermal regulation device in this case having six sets of two ribs that participate in delimiting three coolant fluid circulation ducts,

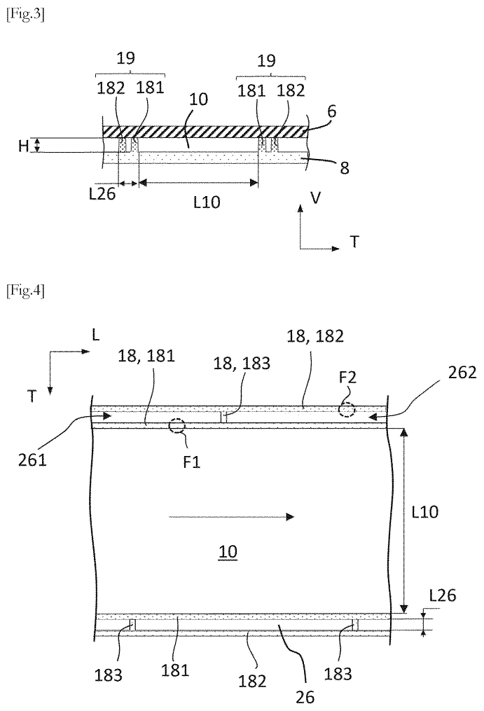

FIG. 3 shows a detail of the thermal regulation device, seen from above, without the support plate so as to reveal the arrangement of two sets of two ribs delimiting a coolant fluid circulation duct and partitioning ribs arranged across a buffer zone formed between two ribs of a given set of ribs,

FIG. 4 is a detailed view of FIG. 2, in particular showing two sets of two ribs delimiting a coolant fluid circulation duct, and schematically showing a ratio between the height of the ribs and the width of the refrigerant fluid circulation duct.

The features, variants and different embodiments of the invention may be associated with one another in different combinations, where not incompatible or mutually exclusive. In particular, it is possible to envisage variants of the invention that comprise only a selection of features described below, independently of the other features described, if this selection of features is sufficient to confer a technical advantage or to differentiate the invention from the prior art.

In the figures, elements common to several figures have the same reference sign.

The description below makes reference to an orientation according to longitudinal, vertical and transverse axes, as defined arbitrarily by the trihedron L, V, T shown in the figures. The names chosen for these axes do not limit the orientation of the device when used in a motor vehicle.

FIG. 1 therefore schematically illustrates a thermal regulation device 1 according to the invention that is intended to regulate the temperature of one or more electric energy storage members 100 of an electric or hybrid vehicle. In the example illustrated, a plurality of cells 102 of rectangular section are juxtaposed to form the electric energy storage member, but it should be noted that this shape does not limit the invention and that cylindrical cells could also be thermally regulated by the device, which is described in greater detail below.

The thermal regulation device 1 extends primarily in a longitudinal direction and is delimited in this direction by a first longitudinal end 2 and a second longitudinal end 4. The thermal regulation device 1 comprises at least one support plate 6 and one distribution plate 8 between which are delimited circulation ducts 10, which are distributed substantially over the entire surface of the distribution plate to ensure the optimum and uniform cooling of the electric energy storage member.

The circulation ducts 10 are intended to be traversed by a coolant fluid, for example glycol water, without this selection limiting the invention. The refrigerant fluid recovers the calories released by the electric energy storage members by heat transfer via the support plate, which is made of metal and notably aluminum. The refrigerant fluid may therefore refer to any type of cooling solution, such as water, glycol water, oil or any other liquid or gas refrigerant fluid used in the fields in question.

According to the invention, the support plate 6 and the distribution plate 8 are substantially planar parts that extend primarily in a longitudinal/transversal plane.

The thermal regulation device 1 is arranged in relation to the electric energy storage member 100 such 20 that the support plate 6 faces this electric energy storage member.

More specifically, the support plate 6 has an opposing outer face 12, which is intended to be in contact with the electric energy storage member 100, and an inner face 14, which is arranged to face the distribution plate 8 and that participates in defining with the latter, and more specifically an inner face 16 of this distribution plate 8, the refrigerant fluid circulation ducts 10.

As described more specifically below, ribs 18 are arranged substantially perpendicularly to the inner face 16 of the distribution plate 8 and to the inner face 14 of the support plate 6 to delimit one of the circulation ducts 10.

The support plate 6 is therefore made of a metal to enable the calories released by operation of the electric energy storage member 100 to be evacuated toward the refrigerant fluid and then out of the thermal regulation device 1. The distribution plate 8 is made of a different material from the material used to make the support plate 6, specifically a non-metal material, thereby limiting the carbon footprint of the thermal regulation device 1 according to the invention. More specifically, the distribution plate 8 is made of plastic and/or composite.

In the illustrated example, the circulation ducts 10 of the refrigerant fluid extend between the distribution plate 8 and the support plate 6 from the vicinity of the first longitudinal end 2 of the thermal regulation device 1 to the vicinity of the second longitudinal end 4 of the thermal regulation device 1, and they include more specifically a distribution duct 10a in communication with a fluid inlet 20, three main ducts 10b that are respectively supplied by the distribution duct 10a and that open respectively into a manifold duct 10c in communication with a fluid outlet 22. In this case, the thermal regulation device 1 has three parallel main ducts 10b, but it should be noted that a different number of circulation ducts 10, 10a, 10b, 10c or a different arrangement of these circulation ducts 10 could be used without departing from the scope of the invention.

As already mentioned, the support plate 6 and the distribution plate 8 are secured to each other to delimit refrigerant fluid circulation ducts 10 therebetween and, according to the invention, these plates 6, 8 made of different materials are secured to each other using ribs 18.

The ribs 18 are integral with one of the plates 8 and the free end 24 thereof, opposite said plate from which they project, is secured to the other plate 6 by a suitable fastening operation. More specifically, the ribs 18 are made to form a one-piece assembly with the distribution plate 8, and are then secured to the inner face 14 of the support plate 6. The fastening operation securing the ribs 18 to the support plate 6 may be a bonding operation, the adhesive being deposited in advance on the free ends 24 of each of the ribs 18 before attaching the support plate 6 to the assembly formed by the distribution plate 8 and the glued ribs 18 thereof. Alternatively, the fastening operation may involve depositing a primary adhesion coating on the free end face of the ribs 18 then applying localized heating to the contact zone between the support plate 6 and these ribs 18 to adhere the metal support plate 6 and the polymerized coating by heating, the assembly then being pressed and left to cool.

Regardless of the fastening operation used, the ribs 18 may be overmolded initially on the distribution plate 8 in order to form projections from the inner face 16 of this plastic distribution plate 8.

Alternatively, each of the ribs may be formed by a local deformation of the distribution plate 8.

As shown notably in FIGS. 2 to 4, at least one of the circulation ducts 10 is delimited transversely, on at least one side, by a set 19 of two parallel ribs 18. Advantageously, all of the fluid circulation ducts 10 are delimited laterally, on each side, by a set 19 of two parallel ribs 18, regardless of whether these ducts are distribution ducts 10a, manifold ducts 10c, or the main ducts 10b and the joins thereof.

The sets 19 of two ribs 18 thus delimit, at least partially, the refrigerant fluid circulation ducts 10. As particularly visible in FIG. 2, the sets 19 of two ribs 18 form side walls of the circulation ducts, while on one hand the inner face 14 of the support wall 6 forms the upper walls of each circulation duct 10 and the inner face 16 of the distribution wall 8 forms the lower walls of each circulation duct 10. In at least one specific zone of the thermal regulation device, a rib (not shown here) is open to enable the corresponding circulation duct to communicate with the inlet and/or the outlet to enable the refrigerant fluid to be supplied and/or evacuated.

Each set 19 of two parallel ribs is formed by a guide rib 181, which is the innermost rib 18 in relation to the circulation duct 10 that the set of ribs participates in delimiting, and that therefore participates directly in delimiting the circulation duct 10, and a reinforcement rib 182, which is the outermost rib 18 in relation to the circulation duct 10 that the set of ribs participates in delimiting, and that extends parallel to the guide rib 181 thereby creating a buffer zone 26 of constant width. The width L26 of the buffer zone 26 is measured, as illustrated in FIGS. 3 and 4, between the two ribs of a given assembly 19, substantially parallel to the plane of elongation of the support and distribution plates between which the ribs extend.

The reinforcement rib 182 stops any droplets of refrigerant fluid that have oozed between the support plate 6 and the guide rib 181, thereby providing a supplementary sealing stage preventing fluid from circulating between the plates 6, 8 from one circulation duct 10 to the other.

The thermal regulation device according to the invention may further include at least one partitioning rib 183 that is arranged, according to the guide and reinforcement ribs 181, 182, perpendicularly to the support and distribution plates 6, 8, and that is arranged across the buffer zone 26 formed between the two ribs 18 of a given set 19, and perpendicular thereto. As a result, for a buffer zone 26 formed between two ribs of a given set 19 of ribs along a refrigerant fluid circulation duct 10, the buffer zone 26 is partitioned into two neighboring sections and sealing performance is improved: if a first leak zone is created by misassembly or wear between the guide rib 181 and the support plate 6 in a first section 261 of the buffer zone, as shown schematically by the point F1, any refrigerant fluid entering the buffer zone 26 through this leak zone cannot escape through a second leak zone between the buffer zone 26 and the reinforcement rib in a second section 262 of the buffer zone, on the other side of the partitioning rib 183, as shown schematically by point F2.

Furthermore, these partitioning ribs 183 increase the fastening surface, by bonding or by hot deformation of a filler coating, between the ribs 18 and the support plate 6 so as to further press the support plate 6 against the ribs 18, thereby limiting the risk of the support plate 6 becoming detached under the pressure of the refrigerant fluid flowing through the circulation ducts 10, which further improves fluidtightness.

As illustrated in FIG. 4, the partitioning ribs 183 may be arranged in a staggered pattern, considering the placement thereof on both sides of a refrigerant fluid circulation duct 10.

All of the ribs 18, whether guide ribs 181, reinforcement ribs 182 or partitioning ribs 183, are of substantially the same height H, i.e. a dimension measured in a vertical direction perpendicular to the support plate 6 and the distribution plate 8, to enable the support plate 6 bearing against the free end 24 of each rib 18 to be arranged parallel to the distribution plate 8 from which each of the ribs 18 projects.

In the illustrated example, the ribs 18 have a height H of the order of 2 mm to 5 mm, and are arranged at a distance from one another to form a buffer zone of width L26 of approximately 1 mm, the buffer zone being taller than it is wide.

According to the invention, the ribs 18 are dimensioned to satisfy a ratio between the width L10 of the circulation duct 10 delimited between two sets 19 of two ribs 18, measured transversely between two guide ribs 181, and the height H of the ribs 18 of these sets 19, measured vertically between the support plate 6 and the distribution plate 8. More specifically, this ratio may be of the order of 1:10,with the width L10 of the circulation duct being substantially ten times greater than the height H of the ribs 18. In the aforementioned example in which the height of the ribs 18 is of the order of 2 mm to 5 mm, the width L10 of the circulation duct 10 may be approximately 20 mm.

The invention as described above achieves the stated objectives, notably of proposing a thermal regulation device that is both thermally efficient and has a limited carbon impact, by proposing plates between which a refrigerant fluid flows and against one of which the electric energy storage members are arranged, with a double row of ribs laterally bordering each circulation duct of this refrigerant fluid. Variants that are not described here could be implemented without departing from the context of the invention, provided that, in accordance with the invention, they comprise at least one set of two parallel ribs that participate in transversely delimiting one side of a refrigerant fluid circulation duct.

1. A thermal regulation device for an electric energy storage member, the thermal regulation device comprising:
at least one support plate and at least one distribution plate secured to each other so as to delimit one or more circulation ducts for circulating a refrigerant fluid therebetween,
wherein the at least one support plate and the at least one distribution plate are two substantially planar plates secured to each other by means of ribs extending perpendicularly to each of the two substantially planar plates, and
wherein the ribs participate in delimiting the one or more circulation ducts, such that at least one of the one or more circulation ducts being is delimited transversely, on at least one side, by a set of two parallel ribs.

2. The thermal regulation device as claimed in claim 1, wherein each of the ribs of the set of two parallel ribs extend in a main direction of a side of the one or more circulation ducts that the set of two parallel ribs participates in delimiting.

3. The thermal regulation device as claimed in claim 1 wherein the at least one support plate has an outer face intended to be in contact with the electric energy storage member and an inner face facing the at least one distribution plate.

4. The thermal regulation device as claimed in claim 1 wherein the at least one distribution plate has an inner face intended to face the at least one support plate, the set of two parallel ribs participating in delimiting the one or more circulation ducts being arranged substantially perpendicular to the inner face of the at least one distribution plate and to the inner face of the at least one support plate.

5. The thermal regulation device as claimed in claim 1, wherein a partitioning rib is arranged across two ribs of at least one set of two parallel ribs delimiting one side of a circulation duct.

6. The thermal regulation device as claimed in claim 1, wherein a ratio between a width of a circulation duct and a height of the ribs is between 1:5 and 1:7.

7. The thermal regulation device as claimed in claim 1, wherein the at least one support plate and the at least one distribution plate are made of different materials.

8. The thermal regulation device as claimed in claim 7, wherein the at least one support plate is made of a metal and the at least one distribution plate is made of a plastic.

9. The thermal regulation device as claimed in claim 1, wherein the ribs are overmolded on the at least one distribution plate.

10. The thermal regulation device as claimed in claim 1, wherein each of the ribs is formed by a local deformation of the at least one distribution plate.
